(19) United States
(12) Patent Application Publication
(10) Pub. No.: US 2025/0083401 A1
(43) Pub. Date: Mar. 13, 2025

(54) Mold for Manufacturing a Thermoset Optical Article, Method for Manufacturing the Mold and Method for Manufacturing the Thermoset Optical Article

(71) Applicant: ESSILOR INTERNATIONAL, Charenton-le-Pont (FR)

(72) Inventors: Nisachon KONGTARA, Bangkok (TH); Laurie MARION, Bangkok (TH); Tipparat LERTWATTANASERI, Bangkok (TH); Pierre FROMENTIN, Bangkok (TH)

(21) Appl. No.: 18/580,650

(22) PCT Filed: Jul. 18, 2022
(86) PCT No.: PCT/EP2022/070102

§ 371 Date: Jan. 19, 2024

(30) Foreign Application Priority Data
Jul. 19, 2021 (EP) 21306019.7

(51) Int. Cl. B29D 11/00; B29C 33/58; B29C 33/60; B29C 33/72; B29K 75/00

(52) U.S. Cl. CPC B29D 11/0048; B29C 33/58; B29C 33/60; B29C 33/72; B29D 11/00125; B29K 2075/00; B29K 2909/08; B29K 2995/0031

(57) ABSTRACT

A mold for manufacturing a thermoset optical article having a high refractive index, a method for manufacturing the mold, and a method for manufacturing the article. The mold (1) is configured for manufacturing a thermoset optical article capable of being a poly thiourethane-based lens substrate having a refractive index of from 1.54 to 1.74, by casting a thermosetting material (6) into a molding cavity (5) of the mold, the mold comprising a mineral first mold part (2) having a mineral first inner surface (2a) modified by an organosilane mold-release agent. The modified first inner surface (4) comprises a product of a dehydration-condensation reaction of a hydrolysate of an aqueous alcohol solution of the organosilane mold-release agent applied to the mineral first inner surface (2a) and cured thereon, and the modified first inner surface (4) is devoid of a coating layer of particles and is configured to be directly in contact with the cast thermosetting material.

### FIELD OF THE INVENTION

The present invention relates to a mold configured for manufacturing a thermoset optical article, in particular an ophthalmic article, capable of being a polythiourethane-based lens substrate having a high refractive index, to a method for manufacturing the mold, and to a method for manufacturing this thermoset optical article by casting a thermosetting material into this mold. The invention particularly applies to a mold for such a lens substrate having an ultra-high refractive index for example of from 1.54 to 1.74, and optionally having a microstructured main surface.

### DESCRIPTION OF RELATED ART

Ever thinner and therefore lighter plastic ophthalmic lenses are currently needed for ophthalmic use. As higher refractive indices (RIs below) knowingly allow to obtain thinner ophthalmic lenses, plastic lens substrates having ultra-high RIs are more and more required in the ophthalmic market.

In a known manner, thermoset ophthalmic lens substrates may be manufactured by casting and then curing a thermosetting material into a molding cavity of a mineral mold usually comprising two mold parts of mineral glass. Such lens substrates having ultra-high RIs are often difficult to be demolded (i.e. released from the molding cavity) with good yields.

Conventionally, release agents are incorporated into the thermosetting material to be cast, but with the drawback that such internal release agents do not always impart all required performances to the thermoset substrate, particularly to polythiourethane-based substrates having an ultra-high RI of about 1.74.

In addition to these demolding problems for such ultra-high RI substrates, in case the mineral glass inner face of the mold has a carved microstructured pattern configured to form a microstructured main surface on the cast and thermoset substrate, this microstructured pattern must be protected against well-known defects resulting from casting/curing steps, to ensure a longer shelf-life for such a patterned mineral mold.

JP2008-238522 A relates to a glass mold-releasing agent for releasing a plastic molded article from the glass mold when manufacturing the plastic molded article by using a thermosetting resin having high refractive index. The glass mold-releasing agent comprises a fluorine-containing silane compound of high water-repellency. Specifically, the exemplified fluorine-containing silanes have a perfluoropolyether or perfluoroalkylether group, and are dissolved in a fluorous organic solvent which is a perfluorohexane.

A major drawback of the external releasing agent disclosed in JP2008-238522 A resides in the perfluorinated solution applied to the inner face of the mineral glass mold, which does not allow to obtain all required properties for the demolded thermoset ophthalmic lens.

WO2019/030264 A1 relates to an optical article having a substrate made of an optical material comprising a polymer matrix and an improved abrasion and/or scratch resistance. The substrate comprises an external layer in which particles functionalized by a silane coupling agent are embedded into the polymer matrix, the Bayer value of said substrate determined in accordance with the ASTM F735-81 standard being at least 30% greater than the Bayer value of the same substrate with no embedded particles.

This optical article is prepared by successively covering the inner face of the mold by a layer of inorganic particles, filling the mold with a polymerizable composition contacting the covering layer of particles, curing the composition and demolding the cured substrate. This layer of particles which is thus transferred to the cured substrate is intended to improve the abrasion and/or scratch resistance of its external layer, in which the particles are embedded. The inner face of the mold, when made of glass, may be capped with an aqueous alcohol solution of an organosilane (preferably octyltriethoxysilane) before being covered by said particles, to favor demolding of the cured substrate incorporating the embedded particles.

It may be noted that the exemplified polymer matrix of WO2019/030264 A1 still comprises an internal mold-release agent, and that the inner face of the mold, once coated with the capping solution, must further be covered by said layer of particles to impart satisfactory mechanical properties to the cured substrate.

### SUMMARY OF THE INVENTION

An object of the invention is to provide a mold configured for manufacturing a thermoset optical article, such as an ophthalmic article, capable of being a polythiourethane-based lens substrate having a refractive index of from 1.54 to 1.74 (thus including ultra-high RI substrates) by casting a thermosetting material into a molding cavity of the mold, the mold comprising a mineral first mold part having a mineral first inner surface modified by an organosilane mold-release agent, which allows to overcome at least the above-mentioned drawbacks.

According to a first aspect of the invention, the modified first inner surface of the mold comprises a product of a dehydration-condensation reaction of a hydrolysate of an aqueous alcohol solution of the organosilane mold-release agent applied to the mineral first inner surface and cured thereon, and the modified first inner surface is devoid of a coating layer of particles and is configured to be directly in contact with the cast thermosetting material.

It is to be noted that a mold of the first aspect of the invention allows to obtain an improved mold disassembly of the thermoset optical article, such as an ophthalmic article, together with a satisfactory chemical stability of said modified first inner surface and also satisfactory mechanical properties and ophthalmic performances for the obtained substrate, whilst not having to cover said modified first inner surface by a layer of particles, nor having to incorporate any internal release agent into the thermosetting material to be cast, both contrary to the teaching of WO2019/030264 A1.

Specifically, a mold of the first aspect of the invention particularly allows to improve at the same time:
the mold disassembly of the thermoset optical article, which may advantageously be a polythiourethane-based lens substrate having a refractive index of 1.74, for example, thanks to an unexpectedly stable hydrophobicity of said modified first inner surface even after harsh washing/cleaning cycles daily applied to the mold (witnessed by a stable water contact angle despite such cycles),
the transparency of the obtained substrates (witnessed by a high enough relative light transmission factor in the visible spectrum, noted Tᵥ, as defined in standard NF EN 1836) without haze defects or stains thereon,
without hampering the mechanical properties and also the ophthalmic performances of the substrate, particularly in case the mineral first inner surface of the mold had a microstructured pattern to replicate it on a microstructured main surface on the thermoset article (as explained below), while protecting this microstructured pattern via said modified first inner surface according to the first aspect of the invention and thus extending the shelf-life of such a patterned mineral mold.

More specifically, it may be noted that said modified first inner surface of the mold according to the first aspect of the invention allows to suppress the strong bonds, that exist between the labile protons on the first inner surface of the first mold part before its modification and the polymerizable monomer(s) of the thermosetting material and that render the thermoset material difficult to be demolded, by capping all or part of these labile protons so as to make them less reactive and to subsequently improve the mold disassembly of the thermoset material. Indeed, the organosilane mold-release agent reacts with the first inner surface by reactive silanols generated via said reaction, which reactive silanols confer hydrophobicity on the modified first inner surface without affecting the properties of the thermoset article.

It is further to be noted that this unexpected resistance of said modified first inner surface according to the first aspect of the invention to such harsh washing/cleaning cycles daily applied to the mold, which cycles typically include an acid washing, allows to do without an internal release agent in the thermosetting material, since this durable hydrophobicity of said modified first inner surface was found by the inventors to be sufficient to enable an easy and satisfactory disassembly of the thermoset article from the mold only by means of an external release agent made of said product of the dehydration-condensation reaction of said hydrolysate.

The use of a thermosetting material which is free of internal release agent is particularly advantageous according to the first aspect of the invention, since it remedies the known drawbacks inherent to the use of internal release agents in thermosetting materials for ophthalmic substrates which may include a relatively long formulation time of the thermosetting material and also some possible deleterious effects of the internal release agent on ophthalmic performances of the substrate (e.g. in case it has a microstructured main face including lenslets, for example microlenses). Additionally, an ophthalmic substrate devoid of an internal release agent favors current objectives of sustainable development.

Advantageously, said aqueous alcohol solution according to the first aspect of the invention may comprise a mixture of polar protic solvents comprising water, an alcohol which is for example ethanol, methanol or isopropanol, and a carboxylic acid which is for example acetic acid or hydrochloric acid, said aqueous alcohol solution being preferably devoid of an aprotic solvent such as a fluorous solvent.

It may be noted that such an aqueous alcohol solution is very different from the non-aqueous perfluorinated solution using an aprotic solvent which is used in JP2008-238522 A.

Preferably, said aqueous alcohol solution comprises water, ethanol and acetic acid, the vol/vol fraction of ethanol in the solution being more preferably of between 90 and 95%.

According to another feature of the first aspect of the invention, said product of the dehydration-condensation reaction may result from a curing of said hydrolysate in an oven at a temperature of between 90 and 130° C., preferably of between 100 and 120° C. during more than 10 minutes.

Advantageously in relation to any of the foregoing features of the first aspect of the invention, said organosilane mold-release agent may be an aliphatic organoalkoxysilane, which is preferably selected from dimethyl dimethoxysilane (DMDMS), decyltrimethoxysilane (DTMS), triethoxyoctylsilane (OTES) and tridecafluorooctyltriethoxysilane (TDFOTES).

More preferably, said organosilane mold-release agent is not fluorinated, and is still more preferably selected from dimethoxysilane (DMDMS) and decyltrimethoxysilane (DTMS).

It may be noted that both DMDMS and DTMS, when included in said aqueous alcohol solution, were found by the inventors to particularly confer an improved hydrophobicity to the modified first inner surface of the mold according to the first aspect of the invention.

Even more preferably in accordance with a very advantageous embodiment of the first aspect of the invention, said organosilane mold-release agent is decyltrimethoxysilane (DTMS).

It may be noted that DTMS, when included in said aqueous alcohol solution according to the first aspect of the invention, was found by the inventors to confer an even more improved durable hydrophobicity to the modified first inner surface of the mold even after acid washing/cleaning cycles daily applied to the mold, compared to the results obtained with the same vol/vol concentration of DMDMS in said aqueous alcohol solution.

Also advantageously in relation to any of the foregoing features of the first aspect of the invention, said aqueous alcohol solution, in which a vol/vol concentration (i.e. volume fraction) of the organosilane mold-release agent may be equal to or greater than 0.05% and preferably of between 0.05 and 1.5%, may be applied to said mineral first inner surface by dipping the first mold part in said aqueous alcohol solution.

According to a second aspect of the invention, the modified first inner surface of the mold comprises a product of a dehydration-condensation reaction of a hydrolysate of an aqueous solution of the organosilane mold-release agent applied to the mineral first inner surface and cured thereon, and the modified first inner surface is devoid of a coating layer of particles and is configured to be directly in contact with the cast thermosetting material.

It is to be noted that a mold of the second aspect of the invention allows to obtain an improved mold disassembly of the thermoset optical article, such as an ophthalmic article, together with satisfactory mechanical properties and ophthalmic performances for the obtained substrate, whilst not having to cover said modified first inner surface by a layer of particles, nor having to incorporate any internal release agent into the thermosetting material to be cast, both contrary to the teaching of WO2019/030264 A1. After harsh washing/cleaning cycles, a mold of the second aspect of the invention has to be treated again as specified above for obtaining said modified first inner surface of the mold by means of said hydrolysate of the aqueous solution of the organosilane mold-release agent, for the resulting mold to be able to newly provide improved mold disassembly of the thermoset optical article, together with satisfactory mechanical properties and ophthalmic performances for the obtained substrate,

Specifically, a mold of the second aspect of the invention particularly allows to improve at the same time:
the mold disassembly of the thermoset optical article, which may advantageously be a polythiourethane-based lens substrate having a refractive index of 1.74, for example, thanks to the improved hydrophobicity of said modified first inner surface,
the transparency of the obtained substrates without haze defects or stains thereon,
without hampering the mechanical properties and also the ophthalmic performances of the substrate, particularly in case the mineral first inner surface of the mold had a microstructured pattern to replicate it on a microstructured main surface on the thermoset article, while protecting this microstructured pattern via said modified first inner surface according to the second aspect of the invention and thus extending the shelf-life of such a patterned mineral mold.

More specifically, it may be noted that said modified first inner surface of the mold according to the second aspect of the invention allows to suppress the strong bonds, that exist between the labile protons on the first inner surface of the first mold part before its modification and the polymerizable monomer(s) of the thermosetting material and that render the thermoset material difficult to be demolded, by capping all or part of these labile protons so as to make them less reactive and to subsequently improve the mold disassembly of the thermoset material. Indeed, the organosilane mold-release agent reacts with the first inner surface by reactive silanols generated via said reaction, which reactive silanols confer hydrophobicity on the modified first inner surface without affecting the properties of the thermoset article.

It is further to be noted that said modified first inner surface of the mold according to the second aspect of the invention allows to do without an internal release agent in the thermosetting material, since the hydrophobicity of said modified first inner surface was found by the inventors to be sufficient to enable an easy and satisfactory disassembly of the thermoset article from the mold only by means of an external release agent made of said product of the dehydration-condensation reaction of said hydrolysate.

The use of a thermosetting material which is free of internal release agent is particularly advantageous according to the second aspect of the invention, since it remedies the known drawbacks inherent to the use of internal release agents in thermosetting materials for ophthalmic substrates which may include a relatively long formulation time of the thermosetting material and also some possible deleterious effects of the internal release agent on ophthalmic performances of the substrate (e.g. in case it has a microstructured main face including lenslets, for example microlenses). Additionally, an ophthalmic substrate devoid of an internal release agent favors current objectives of sustainable development.

It will be noted that a mold according to the second aspect of the invention has the following relative advantages over a mold according to the first aspect of the invention:
said hydrolysate of the second aspect of the invention is devoid of alcohol, being only aqueous based, thus better conforming to environment, health and safety (EHS) than the hydrolysate of said first aspect;
it involves a lower cost for the formulation of said hydrolysate and therefore a reduced manufacturing process cost; and
it provides an even lower amount of white stains on the modified first inner surface of the mold and is easier to wipe, compared to the modified first inner surface of the mold obtained by said first aspect, as explained below and shown in the appended FIG. 20.

Advantageously, said aqueous solution according to the second aspect of the invention may comprise a mixture of water, a carboxylic acid (for example acetic acid or hydrochloric acid) and cetyltrimethylammonium bromide (CTAB), said aqueous alcohol solution being devoid of an alcohol and of an aprotic solvent such as a fluorous solvent.

Advantageously in the second aspect of the invention, said organosilane mold-release agent may be an aliphatic organoalkoxysilane, which is preferably selected from DMDMS, DTMS, OTES and TDFOTES. More preferably, said organosilane mold-release agent is not fluorinated, and is still more preferably selected from DMDMS and DTMS and even more preferably DTMS which, when included in said aqueous solution, were found by the inventors to confer an improved hydrophobicity to the modified first inner surface of the mold according to the second aspect of the invention.

As for the organosilane mold-release agent (which may for example be DTMS), it may be used according to the second aspect of the invention in a volume concentration (vol/vol fraction) of about 0.5%, being noted that a higher volume concentration may lead to undesirable white stains left on the molds and that a lower volume concentration may hamper hydrophobicity of the modified first inner surface of the mold and therefore the disassembly performance of the thermoset optical article.

As for the CTAB concentration (in mol/L, or M) in the aqueous solution of the second aspect of the invention, it may range from 0.7 mM to 5 mM. If a lower amount of CTAB is used, then it will take a longer time to complete the silane dispersion.

The hydrolysis duration according to the second aspect of the invention may range from 5 hours to 24 hours.

According to another feature of the second aspect of the invention, said product of the dehydration-condensation reaction may result from a curing of said hydrolysate in an oven at a temperature of between 90 and 130° C., preferably of between 100 and 120° C. during about 1 hour (for example of between 45 and 90 minutes).

According to another general feature of the first aspect of the invention which may relate to any of the foregoing features, said modified first inner surface is provided, via covalent bonds, with reactive silanol groups formed from said product of the dehydration-condensation reaction, said reactive silanol groups rendering said modified first inner surface hydrophobic even after a plurality of acid washing cycles implemented by immersion, during 170 to 190 seconds at a temperature of 85-95° C., of the modified first inner surface in a bath of sulfuric acid concentrated at a weight fraction at least 98%.

It is to be noted again that not only these reactive silanol groups allow to suppress most of the labile protons on the first inner surface to render the silanol-modified first inner surface hydrophobic to easy mold disassembly of the thermoset article, but also this modification of the first inner surface of the mold unexpectedly resists to the extremely harsh acid washing treatments daily applied to the mold, thus allowing to do totally without the internal release agents which are usually required in the thermosetting material formulation.

According to another general aspect of the invention which may relate to any of the foregoing ones according to any of the first aspect and the second aspect of the invention, the mold may be further configured to impart to the manufactured thermoset optical article a microstructured main surface, said modified first inner surface having a microstructured pattern configured to directly form said microstructured main surface after casting the thermosetting material in contact with the microstructured pattern, preferably said manufactured thermoset optical article may be an ophthalmic article and preferably said microstructured pattern may be configured to form lenslets, for example microlenses to prevent progression of myopia or hyperopia for a wearer of the thermoset ophthalmic article.

It is to be noted that said modified first inner surface of the mold, which is preferably concave (even though another geometry might be usable), advantageously avoids, after mold disassembly, delamination problems of the demolded thermoset article leading to its rejection, as well as undesirable mold scratches on said microstructured pattern of the mold which result in mold replacement.

Therefore, damages over use due to repeated casting, curing, demolding, harsh washing/cleaning and re-polishing steps to suppress contaminations (among which demolding steps are particularly demanding for the first inner surface of the mold) are avoided, and as a consequence scrapping of the mineral mold parts which are very costly when they incorporate the original microstructured patterns, are minimized or at least significantly delayed.

It may be noted that the thickness of said modified first inner surface which comprises the microstructured pattern is not significantly increased, compared to the thickness of the same first inner surface before being modified, so that said modified first inner surface does not affect the optics of the original microstructured pattern as designed on the mineral mold, which is replicated at a high fidelity on said microstructured main surface of the thermoset optical article.

It may also be noted that the thermoset optical article is advantageously designed to form an ultra-high RI substrate of an ophthalmic lens having a refractive index of from 1.54 to 1.74 which may be a corrective spectacle lens for instance usable to treat or control not only myopia, but also hyperopia, astigmatism and presbyopia.

Specifically, the microstructures which may form the microstructured main surface of the ophthalmic lens substrate may include lenslets. Lenslets may form bumps and/or recesses at the main surface they are arranged onto. The outline of the lenslets may be round or polygonal, for example hexagonal.

More particularly, lenslets may be microlenses. A microlens may be spherical, toric, or have an aspherical shape, rotationally symmetrical or not. A microlens may have a single focus point, or cylindrical power, or non-focusing point.

In preferred embodiments, lenslets or microlenses can be used to prevent progression of myopia or hyperopia. In that case, the base lens substrate comprises a base lens providing an optical power for correcting myopia or hyperopia, and the microlenses or the lenslets may provide respectively an optical power greater than the optical power of the base lens if the wearer has myopia, or an optical power lower than the optical power of the base lens if the wearer has hyperopia.

Lenslets or microlenses may also be Fresnel structures, diffractive structures defining each a Fresnel structure, permanent technical bumps or phase-shifting elements. It can also be a refractive optical element such as microprisms and a light-diffusing optical element such as small protuberances or cavities, or any type of element generating roughness on the substrate. It can also be π-Fresnel lenslets as described in US2021109379 A1, i.e. Fresnel lenslets which phase function has π phase jumps at the nominal wavelength, as opposition to unifocal Fresnel lenses which phase jumps are multiple values of 2π. Such lenslets include structures that have a discontinuous shape. In other words, the shape of such structures may be described by an altitude function, in terms of distance from the base level of the main surface of the ophthalmic lens the lenslet belongs to, which exhibits a discontinuity, or which derivative exhibits a discontinuity.

Lenslets may have a contour shape inscribable in a circle having a diameter greater than or equal to 0.5 micrometers (μm) and smaller than or equal to 1.5 millimeters (mm).

Lenslets may have a height, measured in a direction perpendicular to the main surface they are arranged onto, that is greater than or equal to 0.1 μm and less than or equal to 50 μm.

The main surface can be defined as a surface, that can be a plano, spherical, sphero-cylindrical or even complex surface, that includes the central point of every microstructures. This main surface can be a virtual surface, when microstructures are embedded in the lens or close or identical to the ophthalmic lens physical outer surfaces when microstructures are not embedded. The height of the microstructure can be then determined using local perpendicular axis to this main surface, and calculating for the each point of the microstructure the difference between the maximum positive deviation minus the minimum negative deviation to the main surface, along the axis.

Lenslets may have periodical or pseudo periodical layout, but may also have randomized positions. Exemplary layouts for lenslets may be a grid with constant grid step, honeycomb layout, multiple concentric rings, contiguous e.g. no space in between microstructures.

These structures may provide optical wave front modification in intensity, curvature, or light deviation, where the intensity of wave front is configured such that structures may be absorptive and may locally absorb wave front intensity with a range from 0% to 100%, where the curvature is configured such that the structure may locally modify wave front curvature with a range of +/−20Diopters, and light deviation is configured such that the structure may locally scatter light with angle ranging from +/−1° to +/−30°.

A distance between structures may range from 0 (contiguous) to 3 times the structure (separate microstructures).

According to another feature of the invention which may relate to any of the foregoing ones relating to both the first aspect and second aspect of the invention, the mold may further comprise a mineral second mold part which has a mineral second inner surface opposite to the mineral first inner surface, the molding cavity being defined between the modified first inner surface and the mineral second inner surface, which is preferably modified identically to the modified first inner surface by comprising said product of the dehydration-condensation reaction.

In other terms, a mold of the invention may comprise two mineral first and second mold parts having first and second facing inner surfaces respectively, both being preferably modified as described above in that each of the modified first and second inner surfaces comprises a said product of the dehydration-condensation reaction of said hydrolysate of said aqueous alcohol solution (first aspect) or of said aqueous solution (second aspect) applied to the mineral first inner surface and cured thereon, and each of these modified first and second inner surfaces is devoid of a coating layer of particles and is configured to be directly in contact with the cast thermosetting material.

It is to be noted that said modified second inner surface of the mold, which belongs to the complementary second mold part of the mold that it closes in operation together with the first outer mold part, is optionally microstructured by a microstructured pattern identical to or different from that of said modified first inner surface. This second inner surface may for example be convex in relation to the above-mentioned for example concave first inner surface, although other geometries are usable.

According to a preferred embodiment of the invention which may relate to any of the foregoing ones relating to both the first aspect and second aspect of the invention, said mineral first and second inner surfaces—whether being both microstructured or not as defined above—are each made of mineral glass. Nonetheless, it may be noted that the mineral first mold part may comprise or be made of mineral materials other than mineral glass, such as metal materials or non-metallic materials which are not of plastic type (e.g. not of organic polymeric type).

Another object of the invention is to provide a method for manufacturing a mold as defined above. According to any of the first aspect and the second aspect of the invention, this manufacturing method comprises:
a) Preparing said hydrolysate of the aqueous alcohol solution (first aspect) or of the aqueous solution (second aspect) of the organosilane mold-release agent;
b) Applying the hydrolysate to said mineral first inner surface; and
c) Carrying out said dehydration-condensation reaction of the hydrolysate by curing the applied hydrolysate on the mineral first inner surface, to obtain said modified first inner surface without covering it by a coating layer of particles.

Advantageously, in this method according to the first aspect of the invention for manufacturing a mold:
step a) may successively comprise:
a1) stirring a mixture of several polar protic solvents preferably comprising water, an alcohol which is for example ethanol, methanol or isopropanol, and a carboxylic acid which is for example acetic acid,
a2) dropwise adding the organosilane mold-release agent to the stirred mixture to obtain a hydrolysable solution, preferably at a volume/volume concentration of the organosilane mold-release agent in the hydrolysable solution equal to or greater than 0.05% and for example of between 0.05 and 1.5%, and
a3) hydrolyzing the hydrolysable solution to obtain said hydrolysate for example during 10 to 20 minutes;
and/or
step b) may successively comprise:
b1) dipping the mineral first mold part in said aqueous alcohol solution for example during at least 8 minutes, and
b2) drying the dipped first mold part at a temperature of between 20 and 30° C.; and/or
step c) may successively comprise:
c1) implementing said curing in an oven during 10 to 20 minutes at a temperature of 90 to 130° C., for example of between 100 and 120° C., and
c2) cooling down the cured applied hydrolysate at a temperature of between 20 and 30° C.

More advantageously, in step c), said modified first inner surface may be provided, via covalent bonds, with reactive silanol groups rendering said modified first inner surface hydrophobic, and the method may further comprise, either between sub-steps b1) and b2) or after sub-step c2), an additional washing sub-step by ethanol followed by a drying sub-step at a temperature of between 20 and 30° C., to remove some unreacted silanols from said modified first inner surface.

Advantageously, in the method according to the second aspect of the invention for manufacturing a mold, step a) may successively comprise:
a1) stirring a mixture of water, a carboxylic acid (which is for example acetic acid), and cetyltrimethylammonium bromide (CTAB),
a2) dropwise adding the organosilane mold-release agent (e.g. DTMS) to the stirred mixture to obtain a hydrolysable solution, preferably at a volume/volume concentration of the organosilane mold-release agent in the hydrolysable solution equal to about 0.5%, and
a3) hydrolyzing the hydrolysable solution to obtain said hydrolysate for example during 5 hours to 24 hours.

Also advantageously, in the method according to the second aspect of the invention for manufacturing a mold, step b) may successively comprise:
b1) dipping the mineral first mold part in said aqueous solution for example during at least 8 minutes and for example during 10 minutes, and
b2) rinsing the dipped mineral first mold part by sonicating it in deionized water during about 30 seconds to 60 seconds, in order to remove the CTAB and excess silane (if the rinsing duration is less than 30 seconds, then a higher amount of white stains may remain on the modified first inner surface and the disassembly performance of the thermoset optical article may also be hampered).

Also advantageously, in the method according to the second aspect of the invention for manufacturing a mold, step c) may successively comprise:
c1) implementing said curing in an oven during about 1 hour (for example between 45 and 90 minutes) at a temperature of 90 to 130° C., for example of between 100 and 120° C., and
c2) wiping with a dry cloth the cured applied hydrolysate.

According to another feature of the mold manufacturing method of the invention which may relate to any feature of the above-disclosed general aspect involving a microstructured mold, said mineral first inner surface onto which said hydrolysate is applied in step b) may have a microstructured pattern configured to directly form said microstructured main surface after casting the thermosetting material in contact with the microstructured pattern, and preferably said microstructured pattern is configured to form lenslets, for example microlenses to prevent progression of myopia or hyperopia for a wearer of the thermoset ophthalmic article.

It is to be noted that in the mold manufacturing method of the invention, the mold may comprise two mineral first and second mold parts having first and second facing inner surfaces, respectively, both being advantageously modified and optionally microstructured as described above (i.e. by at least one microstructured pattern), so that both modified first and second inner surfaces are devoid of a coating layer of particles and configured to be directly in contact with the cast thermosetting material.

Another object of the invention is to provide a method for manufacturing a thermoset optical article, such as an ophthalmic article and in particular a polythiourethane-based lens substrate having a refractive index of from 1.54 to 1.74, by casting a thermosetting material into a molding cavity of a mold as defined above. According to the invention (including both its first aspect and second aspect as above presented), this manufacturing method comprises:
A) At least one washing and/or cleaning cycle, for example comprising an immersion of said modified first inner surface of the mold in an acid bath,
B) casting the thermosetting material into the molding cavity, so that the thermosetting material directly contacts said modified first inner surface, which is devoid of said coating layer of particles, and an opposite second inner surface of a mineral second mold part of the mold which is preferably modified identically to the modified first inner surface by comprising said product of the dehydration-condensation reaction,
C) curing the thermosetting material cast in the molding cavity; and
D) demolding the molded thermoset material obtained in step C), comprising releasing the molded thermoset material from the modified first inner surface and second inner surface.

It may be noted that the at least one washing and/or cleaning cycle of step A), which is implemented once said first inner surface of the mold is modified, preferably uses an acid washing (e.g. by sulfuric acid), no basic washing (e.g. by a KOH phase) being used in step A).

Advantageously, in step A), said at least one washing and/or cleaning cycle may successively comprise the following subs-steps:
an acid washing, for example implemented by immersing during a plurality of minutes at 85-95° C. said modified first inner surface and preferably said second inner surface of the mold in a bath of concentrated sulfuric acid,
a dry cleaning of the acid-washed modified first inner surface and second inner surface of the mold, for example by wiping them with a dry cloth, and
a final aqueous washing of the acid-washed and cleaned modified first inner surface and second inner surface, by dipping into an aqueous alcohol bath for example comprising ethanol and deionized water.

Indeed, the inventors discovered that the acid washing sub-step may create an accumulation of silanol groups on the washed modified first and second inner surfaces susceptible to lead to white stains defects thereon, and that the following dry cleaning sub-step effectively allows to get rid of these stains by wiping with a dry cloth, before the cleaned modified first and second inner surfaces are briefly washed in a last sub-step e.g. in said aqueous alcohol bath to remove dust, before casting the thermosetting material into the mold.

According to another feature of this manufacturing method, both the thermosetting material cast in step B) and the demolded thermoset material obtained in step D) may be free of any mold-release agent, and the demolded thermoset material is devoid of an external layer of embedded particles.

As explained above, this manufacturing method of the thermoset article, such as a polythiourethane-based lens substrate having a refractive index of from 1.54 to 1.74, allows to dispense with an internal release agent in the thermosetting material formulation and therefore to obviate all known drawbacks resulting from the presence of such an internal release agent in this formulation (including a complex process and a possible deleterious effect on the lenslets optics in a thermoset microstructured substrate), thus representing a significant improvement over most usual ophthalmic substrates particularly having an ultra-high RI and incorporating a release agent (e.g. a phosphate ester release agent in polythiourethane substrates, without limitation), and contributing to achieve sustainable development objectives.

By way of thermosetting material usable in this manufacturing method, mention may be made of any of the following polymers:
cycloolefin copolymers such as ethylene/norbornene or ethylene/cyclopentadiene copolymers,
homopolymers and copolymers of allyl carbonates of linear or branched aliphatic or aromatic polyols, such as homopolymers of diethylene glycol bis(allyl carbonate),
homopolymers and copolymers of (meth)acrylic acid and esters thereof, which are optionally derived from bisphenol A,
homopolymers and copolymers of thio(meth)acrylic acid and esters thereof,
homopolymers and copolymers of allyl esters which are optionally derived from bisphenol A or phthalic acids, and allyl aromatics such as styrene,
copolymers of urethane and thiourethane,
homopolymers and copolymers of epoxy, and
homopolymers and copolymers of sulfide, disulfide and episulfide.

Although the thermosetting material usable in this manufacturing method is preferably a polythiourethane copolymer, such as so-called “MR-7”, “MR-8”, “MGC N19” or “MR-1.74” lens substrates, it might alternatively be an homopolymer or copolymer of an allyl carbonate of a linear or branched aliphatic or aromatic polyol, such as an homopolymer of diethylene glycol bis(allyl carbonate) e.g. of Orma® name.

In the present description, the terms “comprise” (and any grammatical variation thereof, such as “comprises” and “comprising”), “have” (and any grammatical variation thereof, such as “has” and “having”), “contain” (and any grammatical variation thereof, such as “contains” and “containing”), and “include” (and any grammatical variation thereof, such as “includes” and “including”) are open-ended linking verbs. They are used to specify the presence of stated features, integers, steps or components or groups thereof, but do not preclude the presence or addition of one or more other features, integers, steps or components or groups thereof. As a result, a method, or a step in a method, that “comprises,” “has,” “contains,” or “includes” one or more steps or elements possesses those one or more steps or elements, but is not limited to possessing only those one or more steps or elements.

Unless otherwise indicated, all numbers or expressions referring to quantities of ingredients, ranges, reaction conditions, etc. used herein are to be understood as modified in all instances by the term “about.” Also unless otherwise indicated, the indication of an interval of values «from X to Y» or “between X to Y”, according to the present invention, means as including the values of X and Y.

### DESCRIPTION OF DRAWINGS

FIG. 1 is a schematic partial sectional view of a microstructured mold according to an exemplary embodiment common to the first and second aspects of the invention, with the thermosetting material filling the mold cavity;

FIG. 2 is a schematic sectional view showing the method for measuring the water contact angle (WCA) of a water droplet on the modified inner surface of a mold according to the first and second aspects of the invention;

FIG. 3 is a schematic block diagram showing some steps of a method according to the first aspect of the invention for preparing a capping solution forming said hydrolysate of the aqueous alcohol solution comprising the organosilane mold-release agent;

FIG. 3a is a schematic block diagram showing some steps of a method according to the second aspect of the invention for preparing a capping solution forming said hydrolysate of the aqueous solution comprising the organosilane mold-release agent;

FIG. 4 is a schematic block diagram showing some main steps of an exemplary capping process that was implemented for applying and curing said capping solution to the inner surface of a mold according to the first aspect of the invention;

FIG. 4a is a schematic block diagram showing some main steps of an exemplary capping process that was implemented for applying and curing said capping solution to the inner surface of a mold according to the second aspect of the invention;

FIG. 5 is a schematic block diagram showing the steps of a first capping process deriving from that of FIG. 4 that was implemented for applying and curing a capping solution prepared as in FIG. 3 to the inner surface of a glass slide and measuring the WCAs thereon;

FIG. 6 is a graph showing the measured WCA values for six glass slides capped according to the first process of FIG. 5 with capping solutions comprising DMDMS, MTES, TMES, DTMS, OTES and TDFOTES as an organosilane mold-release agent, respectively, compared to a control glass slide which was not capped;

FIG. 7 is a graph showing the measured WCA values for five glass slides capped according to the first process of FIG. 5 with a capping solution comprising DMDMS as an organosilane mold-release agent at five DMDMS volume concentrations, respectively, with determined other parameters, compared to a control glass slide which was not capped;

FIG. 8 is a graph showing the measured WCA values for five glass slides capped according to the first process of FIG. 5 with a capping solution comprising DTMS as an organosilane mold-release agent at five pH values for the capping solution, respectively, with determined other parameters, compared to a control glass slide which was not capped;

FIG. 9 is a graph showing the measured WCA values for six glass slides capped according to the first process of FIG. 5 with a capping solution comprising DMDMS as an organosilane mold-release agent implementing six hydrolysis durations for the hydrolysis step of FIG. 3, respectively, with determined other parameters, compared to a control glass slide which was not capped;

FIG. 10 is a graph showing the measured WCA values for seven glass slides capped according to the first process of FIG. 5 with a capping solution comprising DMDMS as an organosilane mold-release agent implementing six dipping durations for applying the capping solution to the glass slide, with determined other parameters, compared to a control glass slide which was not capped;

FIG. 11 is a schematic block diagram showing the steps of a second capping process alternative to that of FIG. 5, that was implemented for applying and curing a capping solution prepared as in FIG. 3 to the inner surface of a glass slide and measuring the WCA thereon;

FIG. 12 is a graph showing the measured WCA values for six glass slides capped according to the first capping process (process 1) of FIG. 5 and for six other glass slides capped according to the second capping process (process 2) of FIG. 11, with capping solutions comprising DMDMS, MTES, TMES, DTMS, OTES and TDFOTES each used at a volume of 1.5 mL for each process, compared to a control glass slide which was not capped;

FIG. 13 is a schematic block diagram showing some main steps of an acid washing/cleaning process that was implemented on the modified inner surfaces of UHI (ultra-high index) molds according the first and second capping processes where the capping solutions included DMDMS and DTMS, to test the stability of the WCA of these modified surfaces after several acid washing/cleaning steps;

FIG. 14 is a graph showing the measured WCA values for two UHI mold inner surfaces capped according to the first capping process (P1) of FIG. 5 and washed/cleaned according to FIG. 13 for two capping solutions comprising DMDMS and DTMS each used at a volume of 1.5 mL, and for two other UHI mold inner surfaces capped according to the second capping process (P2) of FIG. 11 and washed/cleaned according to FIG. 13 for two capping solutions including DMDMS and DTMS, compared to a control UHI mold which was not capped;

FIG. 15 is a schematic block diagram showing a succession of washing/cleaning, casting, curing and demolding steps of “MR-8” type substrates molded by the UHI molds, that were implemented on the modified inner surfaces of these UHI molds according to the second capping process;

FIG. 16 contains three photographs of “MR-8” type substrates obtained by the steps of FIG. 15, which from left to right relate to a control uncapped mold, a mold capped with a solution of DMDMS used at a DMDMS volume of 1.5 mL and a mold capped with a solution of DTMS also used at a DTMS volume of 1.5 mL (both capped molds being used without an internal release agent in the “MR-8” substrate composition);

FIG. 17 contains six photographs of “MR-8” type substrates obtained by the steps of FIG. 15, which from left to right relate to a “baseline” substrate obtained with an internal release agent in the “MR-8” composition and without capping the mold, and to five substrates demolded from molds capped according to process 2 with a solution of DTMS (with the DTMS volume varying from 0.05 to 0.25 mL) and filled with a “MR-8” composition without an internal release agent;

FIG. 18 is a schematic block diagram showing a succession of washing/cleaning, casting, curing and demolding steps usable in a substrate manufacturing method according to the first aspect of the invention, which were implemented to mold and demold “MR-8” type substrates by the UHI molds having their modified inner surfaces capped with a solution of DTMS at a DTMS volume of 0.05 mL according to process 2;

FIG. 19 contains eleven photographs of “MR-8” type substrates obtained by the steps of FIG. 15, which show the effect of relative vol. proportions of a dipping ethanol-water mixture, used after acid washing and dry cleaning steps to complete cleaning of a capped mold according to the first aspect of the invention, in optical properties of eleven substrates obtained from molds capped with a solution of DTMS at a DTMS volume of 0.05 mL according to process 2; and

FIG. 20 is a chart including comparative photographs showing the level of visually observed white stains and the easiness of wiping, for UHI molds according to the first aspect of the invention (EtOH-based treatment in the chart) and to the second aspect of the invention (water-based treatment in the chart).

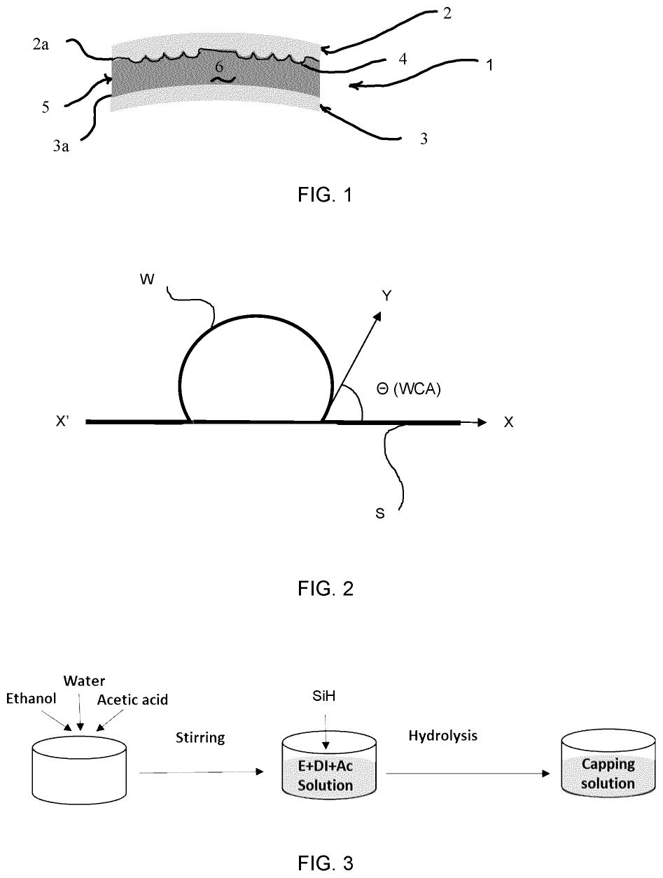

FIG. 1 diagrammatically shows a mold 1 according to an exemplary embodiment of the first and second aspects of the invention, which particularly comprises:
a mineral first mold part 2 (e.g. concave and of mineral glass) which may be microstructured on a first microstructured inner surface 2a thereof, and
a mineral second mold part 3 (e.g. convex and also of mineral glass) having a complementary and second inner surface 3a which may be smooth.

As visible in FIG. 1, the first inner surface 2a of the mold 1 is capped with a capping solution 4 which has been applied thereto by dipping and then cured thereon, to form a modified first inner surface 4 of the mold 1 which is capable of replicating at a high fidelity the original microstructured pattern of the first inner surface 2a, as explained above.

The molding cavity 5 is defined between the modified first inner surface 4 and the second inner surface 3a, and it is configured to be filled by the cast thermosetting material 6 to be cast and then cured in this cavity 5 at a determined temperature, for a certain duration.

After completing curing of the cast thermosetting material 6, the resulting thermoset article, such as an ophthalmic lens substrate configured to treat or control myopia, hyperopia, astigmatism and/or presbyopia, is easily released from the mold 1, as explained below.

In variant embodiments of the invention, the modified first inner surface 2a may be devoid of a microstructured pattern, thus being smooth as well as the second inner surface 3a.

As visible in FIG. 2, hydrophobicity was assessed by measuring the static water contact angles (WCAs) of water droplets W dropped on a biplano mold surface S, all WCA measurements being carried out at 25° C. according to the well-known liquid drop method. It is to be noted that the WVA values θ were defined between the axis X of the surface S, defined by a direction oriented away from the droplet W, and the axis Y starting from the surface S and tangential to the droplet W.

Therefore, the WCA values which were presently determined distinguish over commonly measured WCA (usually defined between the opposite axis X′ of the surface S, oriented towards the droplet W, and the same tangential axis Y), in that the surface S was said to be hydrophobic (respectively hydrophilic) if the angle θ between said X and Y directions was lower than 90° (respectively greater than) 90°. In other words, the presently measured WCA corresponds to the angular difference π−θ as regards usually measured WCA between said directions X′ and Y (π−θ knowingly being greater than 90° for a hydrophobic surface and lower than 90° for a hydrophilic surface).

### EXAMPLES OF MOLDS AND MANUFACTURING METHODS OF THE INVENTION

The following examples illustrate the first and second aspects of the present invention in a more detailed, but non-limiting manner.

The following chemicals, recited in table 1 and also identified by the formulae below, were tested to prepare all capping solutions designed to form the modified first inner surfaces of the UHI tested molds, which were made of mineral glass.

Regarding the thermosetting materials cast into these molds to manufacture the UHI substrates, they were of “MR-8” type, i.e. based on a polythiourethane copolymer and having a refractive index of 1.60, even though they might alternatively be of “MR-1.74” type.

TABLE 1

| Chemicals | CAS number | Purity |
|---|---|---|
| Ethanol | 64-17-5 | >95% |
| Acetic acid | 64-19-7 | 100% |
| Cetyltrimethylammonium bromide (CTAB) | 57-09-0 | >98% |
| Dimethyl Dimethoxy Silane (DMDMS) | 78-62-6 | >95% |
| Triethoxymethylsilane (MTES) | 2031-67-6 | >98% |
| Trimethylethoxysilane (TMES) | 1825-62-3 | 99% |
| Decyltrimethoxysilane (DTMS) | 5575-48-4 | >90% |
| Triethoxyoctylsilane (OTES) | 2943-75-1 | >99% |
| 3,3,4,4,5,5,6,6,7,7,8,8,8- | 51851-37-7 | >97% |
| Tridecafluorooctyltriethoxysilane (TDFOTES) | | |

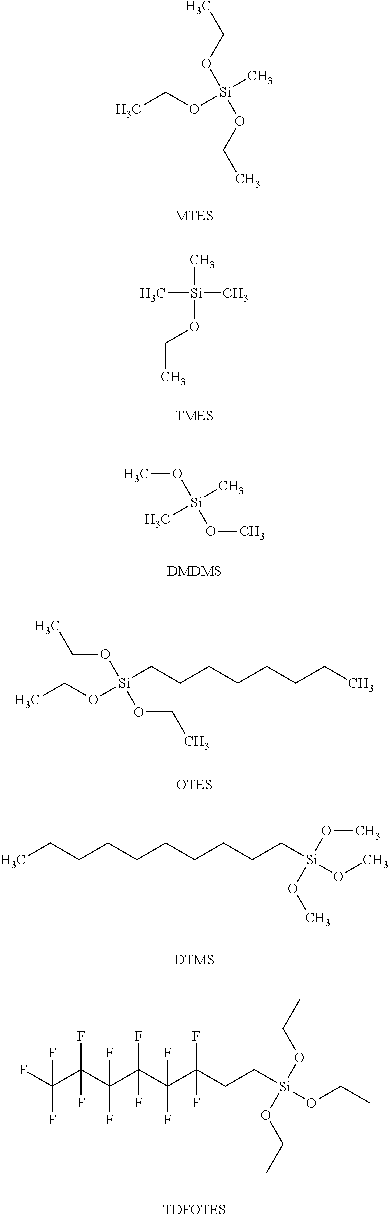

### 1. Methods of the First and Second Aspects of the Invention for Preparing a Capping Solution and for Capping a Mineral Mold Inner Surface

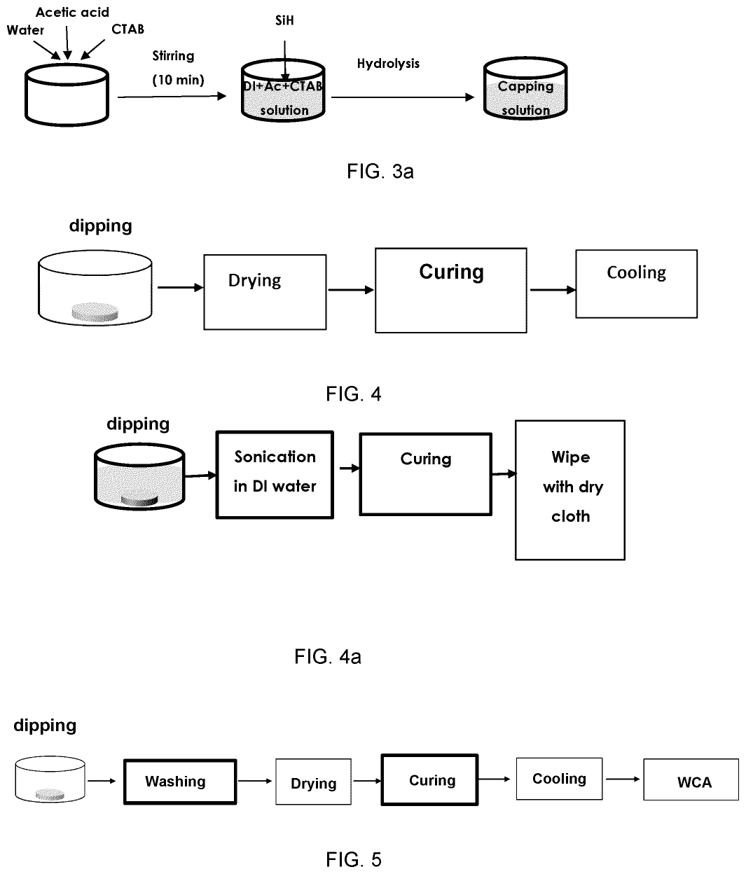

As visible in FIG. 3, ethanol (E), deionized water (DI) and acetic acid (Ac) were added into a container and then stirred for 10 minutes. An organosilane mold-release agent (SiH) was slowly added dropwise to the stirred mixture to obtain an aqueous alcohol solution, and then let to hydrolyse for 15 minutes by stirring, to obtain a hydrolysate forming the capping solution.

As visible in FIG. 3a, deionized water (DI), acetic acid (Ac) and cetyltrimethylammonium bromide (CTAB) were added into the container and then stirred for 10 minutes. An organosilane mold-release agent (SiH, which according to exemplary experiments was DTMS with a vol/vol fraction of 0.5%) was slowly added dropwise to the stirred mixture to obtain an aqueous solution, and then let to hydrolyse for 5 hours to 24 hours by stirring, to obtain a hydrolysate forming the capping solution according to the second aspect of the invention.

As visible in FIG. 4, a mineral glass mold was dipped into this capping solution for 10 minutes. After that, the capped mold was dried at room temperature (RT), then cured in an oven at 110° C. for 15 minutes to implement a dehydration condensation reaction, and finally cooled down to RT.

As visible in FIG. 4a, the mineral glass mold was dipped into this capping solution for 10 minutes to obtain a silane capping. After that, the capped mold was rinsed by being subjected to a sonication in DI water during from 30 seconds to 60 seconds in order to remove CTAB and the excess silane, then cured in an oven at 110° C. for 1 hour to implement a dehydration condensation finishing reaction, and finally wiped with a dry cloth to remove stains.

Table 1a below details two exemplary capping solutions F1 and F2 which were tested according to the second aspect of the invention, in which the CTAB concentration was of 0.7 mM (capping solution F1) or 5 mM (capping solution F2), for a constant vol/vol concentration of DTMS of 0.5% and an hydrolysis time varying from 5 hours to 24 hours for these two capping solutions F1 and F2.

TABLE 1a

| | | |
|---|---|---|
| Chemicals | F1 | F2 |

| | | | | |
|---|---|---|---|---|
| DI water | 95 | mL | 95 | mL |
| Acetic acid | 2.5 | mL | 2.5 | mL |
| DTMS | 0.5 | mL | 0.5 | mL |
| Total | 98 | mL | 98 | mL |

| | | |
|---|---|---|
| CTAB | 0.0250 g | 0.1786 g |
| | (CTAB = 0.0007M = | (CTAB = 0.005M = |
| | 0.255 g/L) | 1.8225 g/L) |

### 2. Experiments for Comparing Hydrophobicity of Capped Mineral Molds According to the First Aspect of the Invention, Depending on the Organosilane Mold-Release Agent and Other Parameters of the Capping Solutions, of Their Preparation Methods and Capping Processes

The experiments were carried out on mineral glass slides, due to the very similar interactions with UHI mineral glass molds.

### a) Influence of the Organosilane Mold-Release Agent:

Several organosilanes having substantial organic parts were tested, as they were susceptible to confer hydrophobicity on the mineral glass surfaces of the slides. The tested silanes were DMDMS, MTES, TMES, DTMS, OTES and TDFOTES. Each formulation was based on 1.5 mL of the organosilane, added dropwise, with afterwards a 15 minutes hydrolysis time and a 10 minutes dipping time as explained above, see table 2 below for the detailed formulations 1-6.

TABLE 2

| Chemicals | Unit | 1 | 2 | 3 | 4 | 5 | 6 |
|---|---|---|---|---|---|---|---|
| Ethanol | mL | 95.00 | | | | | |
| DI water | mL | 5.00 | | | | | |
| Acetic acid | mL | 0.10 | | | | | |
| DMDMS | mL | 1.50 | | | | | |
| MTES | mL | | 1.50 | | | | |
| TMES | mL | | | 1.50 | | | |
| DTMS | mL | | | | 1.50 | | |
| OTES | mL | | | | | 1.50 | |
| TDFOTES | mL | | | | | | 1.50 |

Each capping solution 1-6 was prepared as detailed in § 1) above with reference to FIGS. 3-4.

As visible in FIG. 5, after preparing each capping solution, a glass slide was dipped therein for 10 minutes. Then, the capped surface was washed immediately with ethanol to remove unreacted silanols. After that, each capped glass slide was let to dry at RT to evaporate the remaining solvent, before to be cured in an oven at 110° C. for 15 minutes. This curing step allowed the creation of covalent bonds between newly formed silanols and each capped glass surface. In other words, a dehydration condensation reaction occurred. After cooling down to RT each cured capped glass surface, the hydrophobicity/hydrophilicity of the same was determined by measuring the water contact angle (WCA) as explained above with reference to FIG. 2. (i.e. lower the contact angle was, higher was the hydrophobicity, thus favoring slide disassembly).

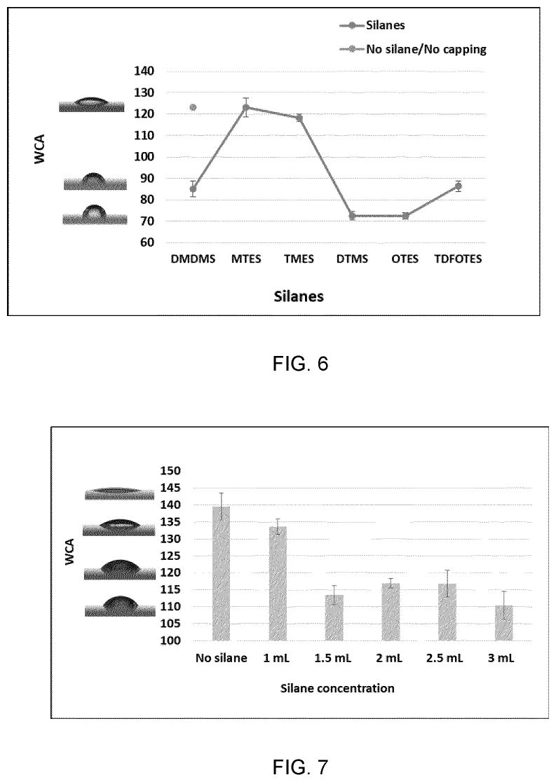

As visible in the graph of FIG. 6 showing the WCAs obtained for the capped slides for different silanes, respectively, DMDMS and DTMS were the ones which provided the most hydrophobic modified surfaces for the capped glass slides (see their WCA of between 70° and 85°, compared to the WCA of more than 120° for the control uncapped glass slide). DMDMS and DTMS seemed also advantageous for being currently available at an acceptable price.

### b) Influence of the Concentration of the Organosilane in the Capping Solutions:

For the purpose of this experiment, DMDMS was used to investigate the effects of silane concentrations. The silane volumes, added dropwise, were varied from 1 mL to 3 mL with a 15 minutes hydrolysis time and a 10 minutes dipping time, as detailed in table 3 below.

TABLE 3

| Chemicals | Unit | 1 | 2 | 3 | 4 | 5 |
|---|---|---|---|---|---|---|
| Ethanol | mL | 95 | | | | |
| DI water | mL | 5 | | | | |
| Acetic acid | mL | 0.1 | | | | |
| DMDMS | mL | 1 | 1.5 | 2 | 2.5 | 3 |

Each capping solution 1-5 was prepared as detailed in § 1) above with reference to FIGS. 3-4, with the above variations of the silane volumes of from 1, 1.5, 2, 2.5 and 3 mL.

The capping steps were implemented by dipping the glass slides into each capping solution 1-5 thus prepared, as detailed in § 2 a) above with reference to FIG. 5.

As visible in the graph of FIG. 7, the WCA measurements showed that at 1 ml of DMDMS, there was no real improvement on hydrophobicity. However, the highest concentration of silane conferred the highest hydrophobicity on the capped slide. Moreover, the deviation around these measurements indicated that no real difference was observed for silane amounts higher than 1.5 mL, which could be due to quantitative silanol conversion.

A volume of 1.5 mL for each organosilane was therefore selected for the following experiments.

### c) Influence of the pH of the Capping Solutions:

The pH of capping solutions 1-5, which were prepared as detailed in § 1) above with reference to FIGS. 3-4, was adjusted by varying the amount of acetic acid as shown in the formulation table 4 below. The formulations were based on 1.5 mL of DTMS, 15 minutes of hydrolysis and 10 minutes of dipping.

TABLE 4

| Chemicals | Unit | 1 | 2 | 3 | 4 | 5 |
|---|---|---|---|---|---|---|
| Ethanol | mL | 95 | | | | |
| DI water | mL | 5 | | | | |
| Acetic acid | mL | 15 | 5 | 2.5 | 1 | 0.1 |

| | | |
|---|---|---|
| DTMS | mL | 1.5 |

The capping steps were implemented by dipping the glass slides into each capping solution 1-5 thus prepared, as detailed in § 2 a) above with reference to FIG. 5.

The pH of capping solutions 1-5 was measured by a pH meter and recorded as an average of 3 measurements.

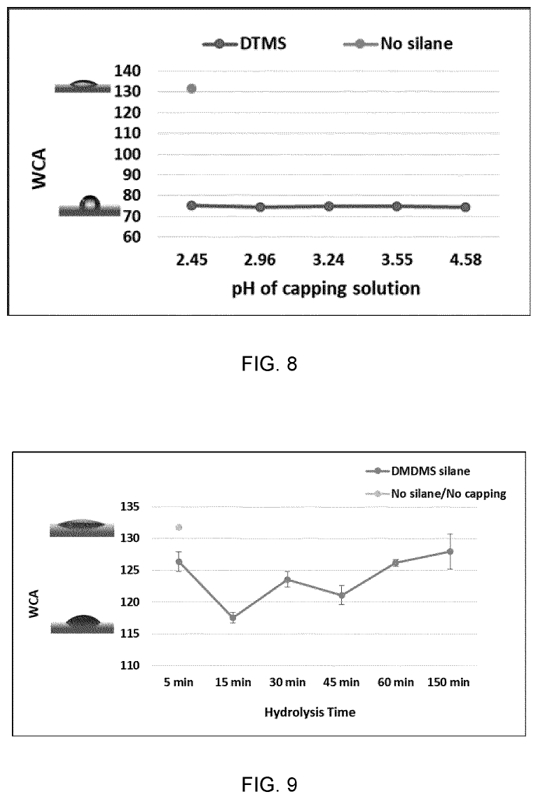

As visible in the graph of FIG. 8, the coupling reaction of DTMS on the glass slide surface, witnessed by the measured WCAs, did not vary much over a wide range of pH.

A pH lower than or equal to 3.24 was selected for the following experiments.

### d) Influence of the Hydrolysis Duration for Preparing the Capping Solutions:

For this experiment, 1.5 mL of DMDMS was selected, the hydrolysis time was varied from 5 to 150 minutes with 10 minutes of dipping time to prepare each capping solution. Each capping solution was prepared as detailed in § 1) above with reference to FIGS. 3-4, with variations of the hydrolysis time of from 5, 15, 30, 45, 60 and 150 minutes.

The capping steps were implemented by dipping the glass slides into each capping solution thus prepared, as detailed in § 2 a) above with reference to FIG. 5.

As visible in the graph of FIG. 9, the highest hydrophobicity (lower WCA) was observed at 15 minutes of hydrolysis time. After 15 minutes, the hydrophobicity decreased (higher WCA), which could be explained by the self-condensation reaction of silanols.

A hydrolysis time of 15 minutes was therefore selected for the following experiments.

### e) Influence of the Dipping Duration for Capping the Mineral Inner Mold Surface:

For the purpose of this experiment, 1.5 mL DMDMS was used to investigate the effects of dipping times, which were varied from 2 to 30 minutes, with a 15 minutes hydrolysis time.

The capping solution was prepared as detailed in § 1) with reference to FIGS. 3-4.

The capping steps were implemented by dipping the glass slide into the capping solution as detailed in § 2 a) above with reference to FIG. 5, with variations of the dipping time of from 2, 5, 8, 10, 15, 20 and 30 minutes.

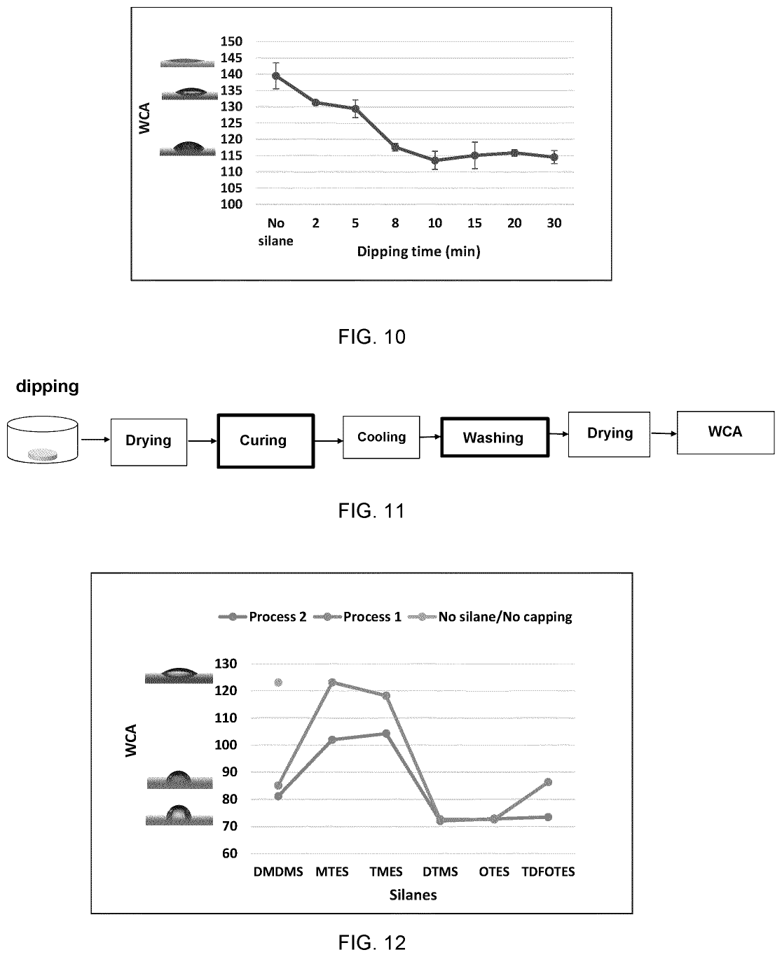

As visible in the graph of FIG. 10, after 8 minutes of dipping time, the WCA was quite low and relatively stable.

A dipping time of 10 minutes was therefore selected for the following experiments.

### f) Influence of the Sequence of the Steps of the Capping Processes:

As visible in FIG. 11, an alternative capping process (process 2) was implemented as a variant embodiment of the capping process of FIG. 5 (process 1), for all the above-detailed capping solutions 1-6 respectively comprising DMDMS, MTES, TMES, DTMS, OTES and TDFOTES, each at a volume of 1.50 mL as in § 2) a) above.

Specifically in process 2, after dipping the slide glass surface in the capping solution for 10 minutes, it was let to dry at RT and then cured at 110° C. for 15 min (dehydration condensation reaction). Next, the capped surface was cooled down to RT, then briefly washed with ethanol to remove some unreacted silanols, and finally dried at RT.

As visible in FIG. 12, process 2 gave better results in terms of hydrophobicity, even though it involved more steps than process 1.

### 3. Experiments for Testing Hydrophobicity Stability of Capped UHI Molds According to the First Aspect of the Invention, After Acid Cleaning vs the Organosilane and Capping Process, and Demolding of “MR-8” Substrates without Internal Release Agent vs the Organosilane, its Concentration and a Final Cleaning Step of the Capped Molds Before Casting

### a) Influence of the Organosilane (at a Volume of 1.5 mL in Capping Solutions) and Capping Process on the Stability of Hydrophobicity After Acid Cleaning Steps:

Acid washing/cleaning stability tests were performed by applying two silanes (DMDMS and DTMS) onto UHI molds made of “MR-8” mineral molds, by testing both above-detailed capping processes “as disclosed above in § 2 a) for “Process 1” and § 2 f) for “Process 2”. The formulation of the tested capping solution was as disclosed in § 2 a), as visible in table 5 below.

TABLE 5

| Chemicals | Unit | Process 1 | Process 2 |
|---|---|---|---|
| Ethanol | mL | 95.00 | |
| DI water | mL | 5.00 | |
| Acetic acid | mL | 2.50 | |
| Dimethyl Dimethoxy Silane (DMDMS) | mL | 1.50 | |
| Decyltrimethoxysilane (DTMS) | mL | | 1.50 |

One point to assess was the daily and harsh mold cleaning in concentrated sulfuric acid. The following experiment checked whether the formed silanols resisted to this harsh chemical cleaning and if so, for how many cycles.

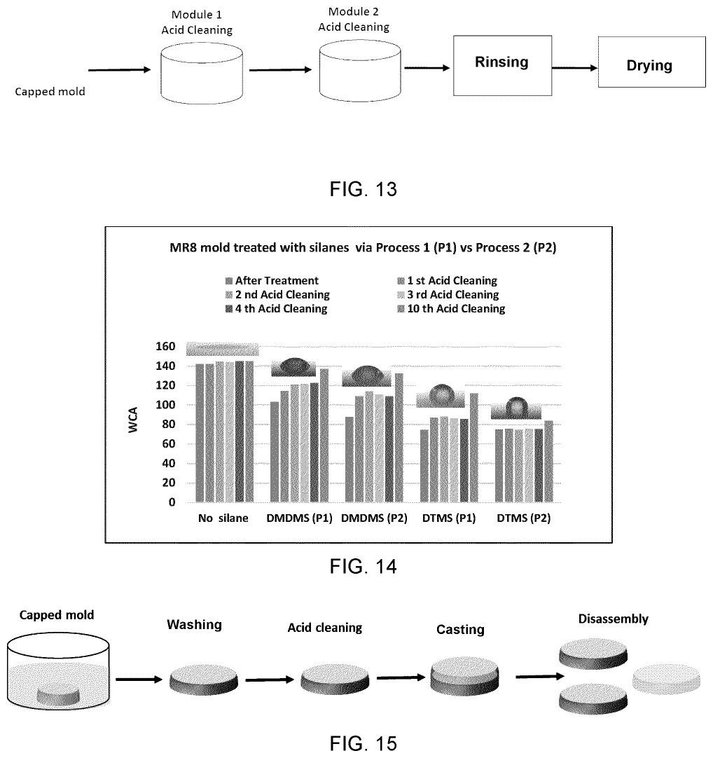

As visible in FIG. 13, each capped mold was successively:
acid cleaned in a module 1 by washing in sulfuric acid (at a concentration greater than or equal to 98%) during an immersion time of 180 s±10 s at a temperature of 90° C.±2° C., and then in a module 2 by the same washing step as module 1,
rinsed with DI water, and then
hot air-dried.

A follow-up on the hydrophobicity of each capped “MR-8” mold after each cleaning cycle was carried out by checking the WCAs as explained above.

As visible in the graph of FIG. 14, silane capping treatments according to Process 2 of FIG. 11 (“P2” in FIG. 14) showed a more stable hydrophobicity (i.e. lower and similar WCAs) than with Process 1 of FIG. 5 (“P1” in FIG. 14), after undergoing acid cleaning cycles.

Process 2 was therefore selected to represent a best mode for the capping process, as it withstood the harsh conditions of acid cleaning better than Process 1. In addition, DTMS provided more hydrophobicity than DMDMS for a given process (see especially the WCAs for Process 2 and for DTMS).

### b) Influence of the Organosilane (at a Volume of 1.5 mL) on Mold Disassembly and Substrate Properties After the Cleaning, Casting and Curing Steps:

Disassembly tests were performed by applying two capping solutions comprising DMDMS and DTMS as silanes, respectively, onto the inner surfaces of “MR-8” molds. Formulations of both capping solutions and capping processes for mold capping were as disclosed above in § 1, see table 6 below for details.

TABLE 6

| | | | |
|---|---|---|---|
| Chemicals | Unit | Process 1 | Process 2 |

| | | |
|---|---|---|
| Ethanol | mL | 95.00 |
| DI water | mL | 5.00 |
| Acetic acid | mL | 2.50 |

| | | | |
|---|---|---|---|
| DMDMS | mL | 1.50 | |
| DTMS | mL | | 1.50 |

As visible in FIG. 15, after capping each “MR-8” mold, each capped mold was washed briefly in ethanol to remove some remaining unreacted silanols, and then acid-cleaned in the abode-disclosed acid washing process, before implementing the casting and curing steps of the thermosetting material, and the final mold disassembly. To better understand the ability of the mold capping according to the invention to ease disassembly, the capped molds were filled with a “MR-8” type composition without internal mold-release agent, compared to a control uncapped mold filled with a standard “MR-8” composition with an internal mold-release agent as the “baseline” composition (i.e. “witness” thermosetting material). Finish lens substrates were casted and then cured following a usual FSV cycle. Table 7 below details both formulations.

TABLE 7

| | Baseline standard | Capped mold |
|---|---|---|
| | formulation | formulation |
| Chemical | Content | Content |
| Standard “MR-8” FSV | 100% | 100% |
| Releasing agent/Zelec ® UN | 800 ppm | — |

Table 8 below shows the mold disassembly results which were obtained.

TABLE 8

| | Difficult | | Easy | | |
|---|---|---|---|---|---|
| | disassembly | | Disassembly | | |
| Mold capping and filled thermosetting | → | | | | |
| materials | 1 | 2 | 3 | 4 | 5 |
| BASELINE: Uncapped mold | | | x | | |
| Standard “MR-8” formulation with internal | | | | | |
| releasing agent | | | | | |
| CONTROL: Uncapped mold | x | | | | |
| “MR-8” formulation, but without internal | | | | | |
| releasing agent | | | | | |
| DMDMS capped-mold | x | | | | |
| “MR-8 “formulation”, but without internal | | | | | |
| releasing agent | | | | | |
| DTMS capped-mold | | | | | x |
| “MR-8 “formulation”, but without internal | | | | | |
| releasing agent | | | | | |

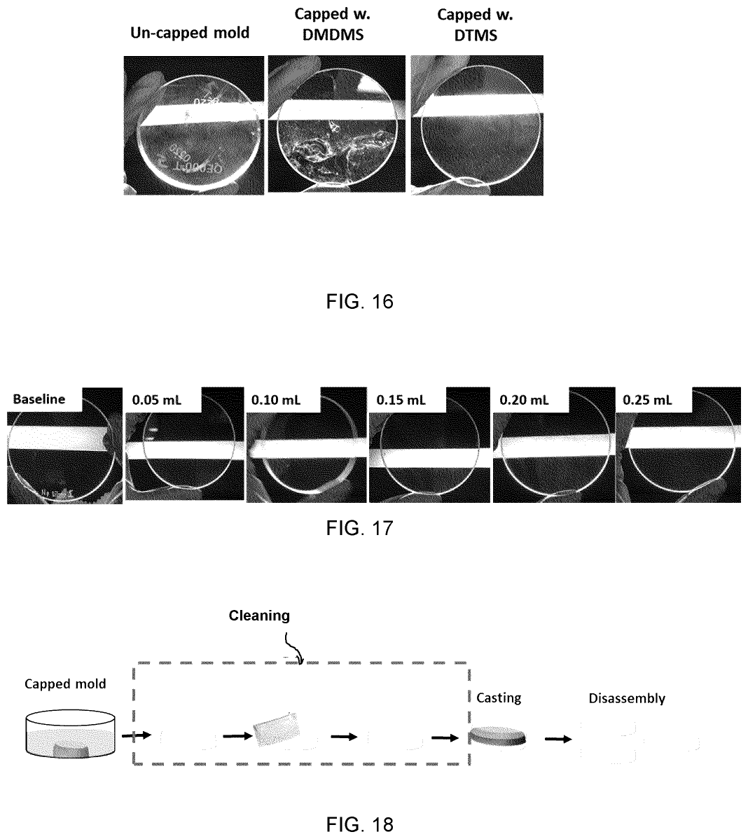

As visible in the photographs of FIG. 16, thermoset “MR-8” type substrates were not able to be disassembled from the uncapped control mold (see photograph on the left), but unexpectedly the thermoset “MR-8” type substrate was much more easily disassembled from the mold capped with DTMS (see photograph on the right), than was the standard MR-8” formulation with an internal releasing agent from the “baseline” uncapped mold. Regarding the the mold capped with DMDMS (see photograph in the middle), it appeared that the thermoset “MR-8” type substrate underwent some delamination after demolding, and was therefore less easily disassembled from the mold than the mold capped with DTMS.

Indeed, the DMTS capping solution showed the best results for mold disassembly. However, haze was observed on the substrate surface because of the accumulation of remaining silanols on the mold surface after the same was treated with acid washing.

### c) Influence of the DTMS Concentration on the Mold Disassembly and Substrate Properties After the Cleaning, Casting and Curing Steps:

As a consequence, supplemental experiments were carried out with said “baseline” uncapped mold as a “witness” experiment, and with five new DTMS-capped molds characterized by lower varying volume concentrations of DTMS in the aqueous alcohol solution, which were obtained by DTMS volumes of 0.05 mL, 0.10 mL, 0.15 mL, 0.20 mL and 0.25 mL, respectively.

As visible in FIG. 17, the DTMS-capped molds which were capped with a very small amount of DTMS (e.g. at a volume of 0.05 mL) gave transparent substrates without affecting mold disassembly, because the hydrophobicity and optical properties of the inner modified mold surfaces were quite stable at a wide range of concentrations, as established by below table 9 which in addition to the measured WCAs, details the relative light transmission factor Tv in the visible spectrum (as defined in standard NF EN 1836 under D65 illumination conditions), the yellowness index YI and the haze value).

TABLE 9

| DTMS volumes | WCA | % TvD65 | YI | Haze |
|---|---|---|---|---|
| 0 mL | 107.3 | 89.5 | 2.4 | 0.26 |
| (Baseline) | | | | |

| | | | | | |
|---|---|---|---|---|---|
| 0.05 | mL | 76.7 | 89.8 | 2.2 | 0.25 |
| 0.1 | mL | 75.4 | 89.9 | 2.2 | 0.25 |
| 0.15 | mL | 75.5 | 89.5 | 2.4 | 0.27 |
| 0.2 | mL | 76.0 | 89.9 | 2.2 | 0.26 |
| 0.25 | mL | 75.2 | 89.8 | 2.2 | 0.28 |

In particular, the hydrophobicity was improved at a volume of the silane agent of about 0.05 mL, while the visible transmittance Tv was at the same time very high and the YI and haze were both minimized.

### d) Influence of the Cleaning Procedure on the Mold Disassembly and Substrate Properties After the Cleaning, Casting and Curing Steps:

As visible in FIG. 18, once the molds were capped with the silane capping solution, they underwent an acid cleaning, which created an accumulation of silanols on the modified inner mold surface which led to white stains defects. To get rid of these stains, a simple wiping of the inner mold surfaces was performed with a dry cloth, before the wiped capped molds were briefly dipped in a mixture of ethanol (EtOH) and deionized water (DI) at different vol/vol ratios, to remove possible dust and/or scratches on the inner mold surfaces before casting and disassembly.

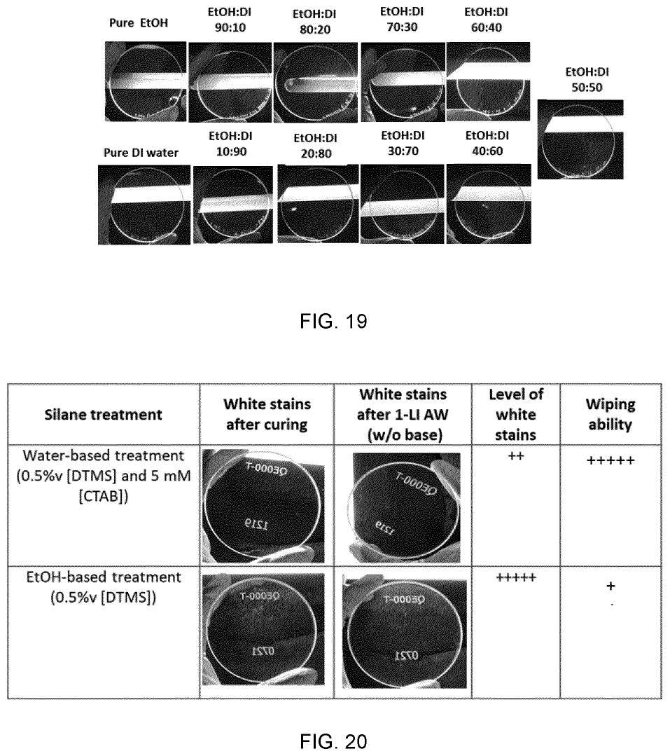

As visible in the photographs of FIG. 19 and in table 10 below, eleven dipping mixtures EtOH:DI were tested to manufacture eleven thermoset substrates, respectively, in order to reduce as much as possible the use of flammable solvents without impacting the cleaning efficiency. The obtained results showed that that all eleven tested mixtures provided transparent substrates without defect and also without affecting hydrophobicity of the inner mold surfaces.

TABLE 10

| EtOH:DI water | WCA | % TvD65 | YI | Haze |
|---|---|---|---|---|
| No silane | 108.3 | 89.8 | 2.2 | 0.27 |
| Pure EtOH | 75.7 | 89.9 | 2.2 | 0.32 |
| 90/10 | 74.2 | 89.7 | 2.1 | 0.31 |
| 80/20 | 74.8 | 89.7 | 2.2 | 0.29 |
| 70/30 | 75.2 | 89.9 | 2.0 | 0.30 |
| 60/40 | 75.2 | 89.8 | 2.1 | 0.26 |
| 50/50 | 75.7 | 89.9 | 2.1 | 0.26 |
| 40/60 | 75.5 | 89.9 | 2.0 | 0.29 |
| 30/70 | 75.7 | 89.8 | 2.1 | 0.29 |
| 20/80 | 74.8 | 89.4 | 2.1 | 0.29 |
| 10/90 | 74.8 | 89.9 | 2.1 | 0.30 |
| Pure water | 75.7 | 89.4 | 2.3 | 0.28 |

And as explained above for the second aspect of the invention, FIG. 20 shows that a mold according to this second aspect (obtained by means of a water-based solution of DTMS and CTAB according to the F2 capping solution of Table 1a) advantageously provides a significantly decreased level of white stains on the modified first inner surface of the mold and a significantly increased wiping ability, compared to the level of white stains and wiping ability of a mold of the first aspect of the invention (obtained by an EtOH-based solution of DTMS).

1. A mold configured for manufacturing a thermoset optical article capable of being a polythiourethane-based lens substrate having a refractive index of from 1.54 to 1.74, by casting a thermosetting material into a molding cavity of the mold, the mold comprising a mineral first mold part having a mineral first inner surface modified by an organosilane mold-release agent,
wherein the modified first inner surface comprises a product of a dehydration-condensation reaction of a hydrolysate of an aqueous alcohol solution of the organosilane mold-release agent applied to the mineral first inner surface and cured thereon, and
wherein the modified first inner surface is devoid of a coating layer of particles and is configured to be directly in contact with the cast thermosetting material.

2. The mold according to claim 1, wherein said aqueous alcohol solution comprises a mixture of polar protic solvents comprising water, an alcohol, and a carboxylic acid, said aqueous alcohol solution being optionally devoid of an aprotic solvent.

3. The mold according to claim 1, wherein said product of the dehydration-condensation reaction results from a curing of said hydrolysate in an oven at a temperature of between 90 and 130° C.

4. The mold according to claim 1, wherein the organosilane mold-release agent is an aliphatic organoalkoxysilane.

5. The mold according to claim 1, wherein said aqueous alcohol solution, in which a volume/volume concentration of the organosilane mold-release agent is equal to or greater than 0.05%, is applied to said mineral first inner surface by dipping the mineral first mold part in said aqueous alcohol solution.

6. The mold according to claim 1, wherein said modified first inner surface is provided, via covalent bonds, with reactive silanol groups formed from said product of the dehydration-condensation reaction, said reactive silanol groups rendering said modified first inner surface hydrophobic even after a plurality of acid washing cycles implemented by immersion during 170 to 190 seconds at 85-95° C. of the modified first inner surface in a bath of sulfuric acid concentrated at at least 98% in weight.

7. The mold according to claim 1, wherein the mold is further configured to impart to the manufactured thermoset optical article a microstructured main surface, said modified first inner surface having a microstructured pattern configured to directly form said microstructured main surface after casting the thermosetting material in contact with the microstructured pattern.

8. The mold according to claim 1, wherein the mold further comprises a mineral second mold part which has a mineral second inner surface opposite to the mineral first inner surface, the molding cavity being defined between the modified first inner surface and the mineral second inner surface, which is modified identically to the modified first inner surface by comprising said product of the dehydration-condensation reaction.

9. A method for manufacturing a mold according to claim 1, wherein the method comprises:
a) Preparing said hydrolysate of the aqueous alcohol solution of the organosilane mold-release agent;
b) Applying the hydrolysate to said mineral first inner surface; and
c) Carrying out said dehydration-condensation reaction of the hydrolysate by curing the applied hydrolysate on the mineral first inner surface, to obtain said modified first inner surface without covering it by a coating layer of particles.

10. The method for manufacturing a mold according to claim 9, wherein:
step a) successively comprises:
a1) stirring a mixture of several polar protic solvents;
a2) dropwise adding the organosilane mold-release agent to the stirred mixture to obtain a hydrolysable solution; and
a3) hydrolyzing the hydrolysable solution to obtain said hydrolysate;
and/or
step b) successively comprises:
b1) dipping the mineral first mold part in said aqueous alcohol solution; and
b2) drying the dipped mineral first mold part at a temperature of between 20 and 30° C.;
and/or
step c) successively comprises:
c1) implementing said curing in an oven during 10 to 20 minutes at a temperature of 90 to 130° C.; and
c2) cooling down the cured applied hydrolysate at a temperature of between 20 and 30° C.

11. The method for manufacturing a mold according to claim 10, wherein in step c) said modified first inner surface is provided, via covalent bonds, with reactive silanol groups rendering said modified first inner surface hydrophobic, and wherein the method further comprises, either between sub-steps b1) and b2) or after sub-step c2), an additional washing sub-step by ethanol followed by a drying sub-step at a temperature of between 20 and 30° C., to remove some unreacted silanols from said modified first inner surface.

12. The method for manufacturing a mold according to claim 9, wherein said mineral first inner surface onto which said hydrolysate is applied in step b) has a microstructured pattern configured to directly form said microstructured main surface after casting the thermosetting material in contact with the microstructured pattern.

13. A method for manufacturing a thermoset optical article, by casting a thermosetting material into a molding cavity of a mold according to claim 1, wherein the method comprises:
A) at least one washing and/or cleaning cycle;
B) casting the thermosetting material into the molding cavity, so that the thermosetting material directly contacts said modified first inner surface, which is devoid of said coating layer of particles, and an opposite second inner surface of a mineral second mold part of the mold which is modified identically to the modified first inner surface by comprising said product of the dehydration-condensation reaction;
C) curing the thermosetting material cast in the molding cavity; and
D) demolding the molded thermoset material obtained in step C), comprising releasing the molded thermoset material from the modified first inner surface and second inner surface.

14. The method for manufacturing a thermoset optical article according to claim 13, wherein in step A), said at least one washing and/or cleaning cycle successively comprises:
an acid washing, implemented by immersing during a plurality of minutes at 85-95° C. said modified first inner surface and second inner surface of the mold in a bath of concentrated sulfuric acid;
a dry cleaning of the acid-washed modified first inner surface and second inner surface of the mold, by wiping them with a dry cloth; and
a final aqueous washing of the acid-washed and cleaned modified first inner surface and second inner surface, by dipping into an aqueous alcohol bath comprising ethanol and deionized water.

15. The method for manufacturing a thermoset optical article according to claim 13, wherein both the thermosetting material cast in step B) and the demolded thermoset material obtained in step D) are free of any mold-release agent, and wherein the demolded thermoset material is devoid of an external layer of embedded particles.

16. The mold according to claim 2, wherein said aqueous alcohol solution comprises said mixture of polar protic solvents comprising water, said alcohol which is ethanol, methanol or isopropanol, and said carboxylic acid which is acetic acid, said aqueous alcohol solution being devoid of said aprotic solvent which is a fluorous solvent.

17. The mold according to claim 3, wherein said product of the dehydration-condensation reaction results from the curing of said hydrolysate in the oven at a temperature of between 100 and 120° C. during more than 10 minutes.

18. The mold according to claim 4, wherein said aliphatic organoalkoxysilane is selected from dimethyl dimethoxysilane (DMDMS), decyltrimethoxysilane (DTMS), triethoxyoctylsilane (OTES) and tridecafluorooctyltriethoxysilane (TDFOTES).

19. The method for manufacturing a mold according to claim 10, wherein:
step a) successively comprises:
a1) stirring the mixture of several polar protic solvents comprising water, an alcohol which is ethanol, methanol or isopropanol, and a carboxylic acid which is acetic acid;
a2) dropwise adding the organosilane mold-release agent to the stirred mixture to obtain a hydrolysable solution, at a volume/volume concentration of the organosilane mold-release agent in the hydrolysable solution of between 0.05 and 1.5%; and
a3) hydrolyzing the hydrolysable solution to obtain said hydrolysate during 10 to 20 minutes;
step b1) comprises dipping the mineral first mold part in said aqueous alcohol solution during at least 8 minutes; and
step c1) comprises implementing said curing in an oven during 10 to 20 minutes at a temperature of between 100 and 120° C.

20. The method according to claim 13 for manufacturing a thermoset optical article, which is a polythiourethane-based lens substrate having a refractive index of from 1.54 to 1.74, wherein in step A), the least one washing and/or cleaning cycle comprises an immersion of said modified first inner surface of the mold in an acid bath.
